(19) United States
(12) Patent Application Publication
(10) Pub. No.: US 2016/0180175 A1
(43) Pub. Date: Jun. 23, 2016

(54) METHOD AND SYSTEM FOR DETERMINING OCCUPANCY

(71) Applicant: POINTGRAB LTD., HOD HASHARON (IL)

(72) Inventors: DAVID BITTON, TEL AVIV (IL); JONATHAN LASERSON, TEL AVIV (IL)

(21) Appl. No.: 14/972,158

(22) Filed: Dec. 17, 2015

Related U.S. Application Data
(60) Provisional application No. 62/093,738, filed on Dec. 18, 2014.

(51) Int. Cl. G06K 9/00; G06T 7/20; H04N 7/18

(52) U.S. Cl. CPC G06K 9/00771; G06K 9/00362; H04N 7/183; G06T 7/20

(57) ABSTRACT

A method and system are provided for automatically determining occupancy in a space by obtaining rotation invariant data from at least one image from a sequence of images of the space; detecting a shape of an occupant in the at least one image based on the rotation invariant data; and determining occupancy based on the detection of the shape of the occupant.

### CROSS-REFERENCE TO RELATED APPLICATIONS

This application claims priority from U.S. Provisional Patent Application No. 62/093,738, filed Dec. 18, 2014, the contents of which are incorporated herein by reference in their entirety.

### FIELD

The present invention relates to the field of occupancy sensing. Specifically, the invention relates to automatic determination of occupancy in a space based on image data of the space.

### BACKGROUND

Building efficiency and energy conservation is becoming increasingly important in our society. One way to conserve energy is to power devices in a controlled space only when those devices are needed. Many types of devices are needed only when an occupant is within a controlled space or in close proximity to such devices. For example, in an office space that includes a plurality of electronic devices such as lighting and HVAC (heating, ventilating, and air conditioning) devices or other environment comfort devices, energy may be conserved by adjusting or turning ON/OFF these devices according to the presence of occupants in the space, according to the number of occupants and/or their location in the space.

The use of sensors to monitor occupancy in rooms and to control various electronic devices or systems in rooms based on occupancy determination, has been explored.

For example, motion detectors, such as ultrasound or optical sensors, are commonly used to determine occupancy in a controlled space. However, these occupancy detecting systems are typically not effective in detecting sedentary occupants since sedentary occupants do not set off a motion detector.

In addition, optical sensors, such as image sensors, used for detecting occupancy may not easily identify an occupant, e.g., sensors may not easily distinguish an occupant from a randomly moving object, such as an animal walking through a room or an inanimate object falling in a room.

Thus, improved methods, systems, and apparatuses are needed for better occupancy detection, building efficiency, operational convenience, and wide-spread implementation of control systems in living and work spaces.

### SUMMARY

Methods and systems according to embodiments of the invention provide automatic accurate occupancy determination thereby providing better understanding of a monitored space, e.g., understanding the number of occupants and/or their location in the space. Understanding of the monitored space may be used for better space utilization, to minimize energy use, for security systems and more. For example, methods and systems according to embodiments of the invention may be used to efficiently control home appliances and environment comfort devices, such as illumination and HAVC devices.

In one embodiment of the invention occupancy is determined based on image data of a space, such as a room. An imager may be positioned in locations in the space, which afford a large field of view, such as on the ceiling of the room. Once occupancy is determined a device may be controlled based on the occupancy determination.

Embodiments of the invention provide a method for automatically determining occupancy in a space, the method including obtaining rotation invariant data from an image of the space; detecting a shape of an occupant in the image based on the rotation invariant data; and determining occupancy based on the detection of the shape of the occupant.

In one embodiment the method may include providing occupancy determination results to a processing unit. The occupancy determination results may be used to monitor a space, to control a device or for other purposes.

In one embodiment the method includes controlling a device based on the determination of occupancy. According to one embodiment controlling a device is based on the detection of the shape of the occupant.

Detecting a shape of an occupant based on rotation invariant data from an image enables to accurately detect a shape of an occupant from any location and/or pose of the occupant within the image especially when the image includes a top view of the space.

Accurately detecting a shape of an occupant and monitoring a space and/or controlling a device based on the detected shape ensures more efficient monitoring of the space and/or control of the device.

Accurately detecting a shape of an occupant also helps to provide continued occupancy detection as opposed to prior art systems that are typically unable to detect continued occupancy, especially of a relatively sedentary occupant.

### BRIEF DESCRIPTION OF THE DRAWINGS

The invention will now be described in relation to certain examples and embodiments with reference to the following illustrative drawing figures so that it may be more fully understood. In the drawings:

FIG. 1 is a schematic illustration of a system according to embodiments of the invention;

FIGS. 2A-C are schematic illustrations of methods for determining occupancy in a space based on rotation invariant data, according to embodiments of the invention;

FIG. 3 is a schematic illustration of a method for determining occupancy in a space based on detection of a top view of a human, according to embodiments of the invention;

FIGS. 4A and 4B are schematic illustrations of methods for determining occupancy in a space, based on identification of human specific features, according to embodiments of the invention;

FIG. 5 is a schematic illustration of a method for determining occupancy in a space based on motion detection, according to embodiments of the invention;

FIG. 6 is a schematic illustration of a method for determining occupancy in a space based on tracking of the occupant, according to embodiments of the invention; and

FIG. 7 is a schematic illustration of a method for determining occupancy in a space based on a scaled search of an occupant, according to embodiments of the invention.

### DETAILED DESCRIPTION

Methods and systems according to embodiments of the invention provide automatic occupancy determination and may provide a means for monitoring and/or understanding and/or controlling an environment (for example, through control of environment comfort devices) based on the occupancy determination.

According to embodiments of the invention “determination of occupancy” or “occupancy determination” or similar phrases relate to a machine based decision regarding the number of occupants in a monitored space, their location in the space, their status (e.g., standing, sitting, sedentary, etc.) and other such parameters related to occupants in the monitored space. “Occupant” may refer to any pre-defined type of occupant such as a human and/or animal occupant or typically mobile objects such as cars or other vehicles.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention provide automatic occupancy determination in a space by detecting a shape of an occupant in an image of the space based on rotation invariant data from images of the space. An understanding of the monitored space based on the occupancy determination may be used to provide information regarding occupant behavior in the space and/or to control a device or devices such as environment comfort devices (e.g., illumination and HAVC devices) or other building or home appliances.

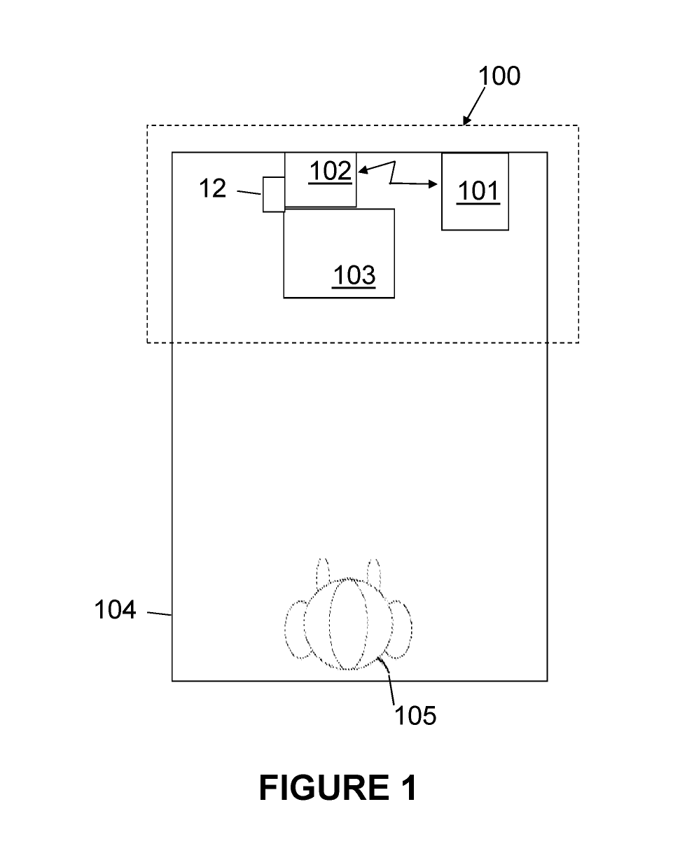

Methods according to embodiments of the invention may be implemented in a system for determining occupancy in a space. A system according to one embodiment of the invention is schematically illustrated in FIG. 1.

In one embodiment the system 100 may include an image sensor such as imager 103, typically associated with a processor 102 and a memory 12. In one embodiment the imager 103 is designed to obtain a top view of the space. For example, the imager 103 may be located on a ceiling of a room 104 (which is, for example, the space to be monitored) to obtain a top view of the room 104.

Image data obtained by the imager 103 is analyzed by the processor 102. For example, image/video signal processing algorithms and/or image acquisition algorithms may be run by processor 102.

Images obtained from a ceiling of a room typically cover a large field of view and contain shapes of top views of occupants. The shape of the top view of an occupant is different at each pose or orientation of the occupant (e.g., a sitting occupant vs. a standing occupant) within the field of view of the imager 103. Additionally, at different locations within a top view image there may be optical distortions due to the large field of view, making detection of a shape of an occupant a difficult task.

Detecting a shape of an occupant based on rotation invariant data from the image, according to embodiments of the invention, enables to accurately detect a shape of an occupant in any pose and from any location within the field of view of the imager thus enabling efficient occupancy determination in systems where top view images of a space are used.

In one embodiment the processor 102, which is in communication with the imager 103, is to obtain rotation invariant data from one or more images (e.g., from a top view image of a space) and to detect a shape of an occupant 105 in the image(s), based on or using the rotation invariant data. A determination of occupancy may be made by processor 102 based on the detection of the shape of the occupant 105 and a signal may be transmitted from processor 102 to another device, e.g., to processing unit 101, as described below. In one embodiment the processor 102 runs a machine learning process, e.g., a set of algorithms that use multiple processing layers on an image to identify desired image features (image features may include any information obtainable from an image, e.g., the existence of objects or parts of objects, their location, their type and more). Each processing layer receives input from the layer below and produces output that is given to the layer above, until the highest layer produces the desired image features. Based on identification of the desired image features an object may be identified as an occupant. According to one embodiment rotated images (e.g., a base image and a mirror image of the base image and/or images rotated at different angles and on different planes relative to the base image) may be presented to the machine learning process during the training phase such that identification of an object as an occupant may be done by the machine learning process based on or using rotation invariant features.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to some embodiments images and/or image data may be stored in processor 102, for example in a cache memory. Processor 102 can apply image analysis algorithms, such as known shape detection algorithms in combination with methods according to embodiments of the invention to detect a shape of an occupant. In one embodiment the processor obtains rotation invariant data from an image. For example, the processor may run algorithms to obtain rotation invariant descriptors from the image. Alternatively or in addition, features or descriptors may be obtained from a plurality of rotated images (e.g., a top view image of the space presented in several rotated positions or several images of the space obtained by rotating the imager 103 several time). Methods for obtaining rotation invariant data from an image or from image data are further detailed below.

In one embodiment the processor 102 is in communication with a processing unit 101. The processing unit 101, may be used to monitor a space (e.g., to issue reports about the number of occupants in a space and their location within the space or to alert a user to the presence of an occupant) or to control devices such as an alarm or environmental comfort devices such as lighting or HVAC devices. The processing unit 101 may control environmental comfort devices, e.g., the processing unit may be part of a central control unit of a building, such as known building automation systems (BAS) (provided for example by Siemens, Honeywell, Johnson Controls, ABB, Schneider Electric and IBM) or houses (for example the Insteon™ Hub or the Staples Connect′ Hub).

The processor 102 may provide occupancy determination results, e.g., by transmitting a signal to the processing unit 101 based on the detection of the shape of the occupant 105 based on rotation invariant data.

The shape of the occupant 105 may be a shape of a top view of a human, A top view of a human may include a top view of at least one of a head, shoulder, leg, arm, face, hair or other human attributes. Alternatively, the shape of an occupant may be a shape of a top view of an animal or typically mobile objects such as cars or other vehicles.

According to one embodiment, the imager 103 and/or processor 102 are embedded within or otherwise affixed to a device such as an illumination or HVAC unit, which may be controlled by processing unit 101. In some embodiments the processor 102 may be integral to the imager 103 or may be a separate unit. According to other embodiments a first processor may be integrated within the imager and a second processor may be integrated within a device.

In some embodiments, processor 102 may be remotely located. For example, a processor according to embodiments of the invention may be part of another system (e.g., a processor mostly dedicated to a system's Wi-Fi system or to a thermostat of a system or to LED control of a system, etc.).

The communication between the imager 103 and processor 102 and/or between the processor and the processing unit 101 may be through a wired connection (e.g., utilizing a USB or Ethernet port) or wireless link, such as through infrared (IR) communication, radio transmission, Bluetooth technology, ZigBee, Z-Wave and other suitable communication routes.

According to one embodiment the imager 103 may include a CCD or CMOS or other image sensor (such as a UV or IR sensor or other sensors that can obtain an image in frequencies below or beyond the visible light range) and appropriate optics. The imager 103 may include a standard 2D camera such as a webcam or other standard video capture device. A 3D camera or stereoscopic camera may also be used according to embodiments of the invention.

According to one embodiment the system 100 may include another sensor (not shown), such as a motion detector e.g., a passive infrared (PIR) sensor (which is typically sensitive to a person's body temperature through emitted black body radiation at mid-infrared wavelengths, in contrast to background objects at room temperature), a microwave sensor (which may detect motion through the principle of Doppler radar), an ultrasonic sensor (which emits an ultrasonic wave and reflections from nearby objects are received) or a tomographic motion detection system (which can sense disturbances to radio waves as they pass from node to node of a mesh network). Other known sensors may be used according to embodiments of the invention.

When discussed herein, a processor such as processor 102 which may carry out all or part of a method as discussed herein, may be configured to carry out the method by, for example, being associated with or connected to a memory such as memory 12 storing code or software which, when executed by the processor, carry out the method.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

According to one embodiment a method for determining occupancy in a space includes detecting a shape of an occupant in an image of the space, using a rotation invariant image feature and determining occupancy based on the detected shape.

For example, the method may include detecting a shape of an occupant in an image or images of the space by running on the image or images a machine learning process trained using rotated images as described above.

Based on the occupancy determination a signal is transmitted, typically to another device or processor for monitoring and/or controlling the space.

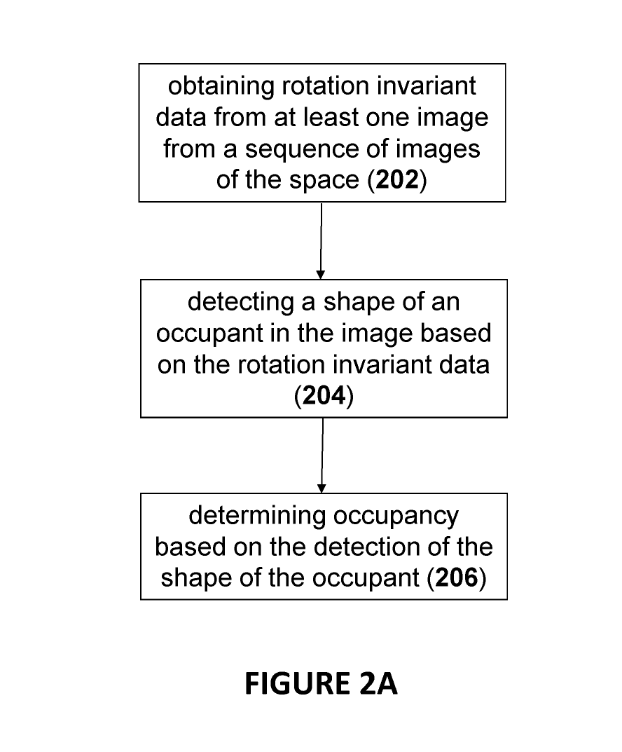

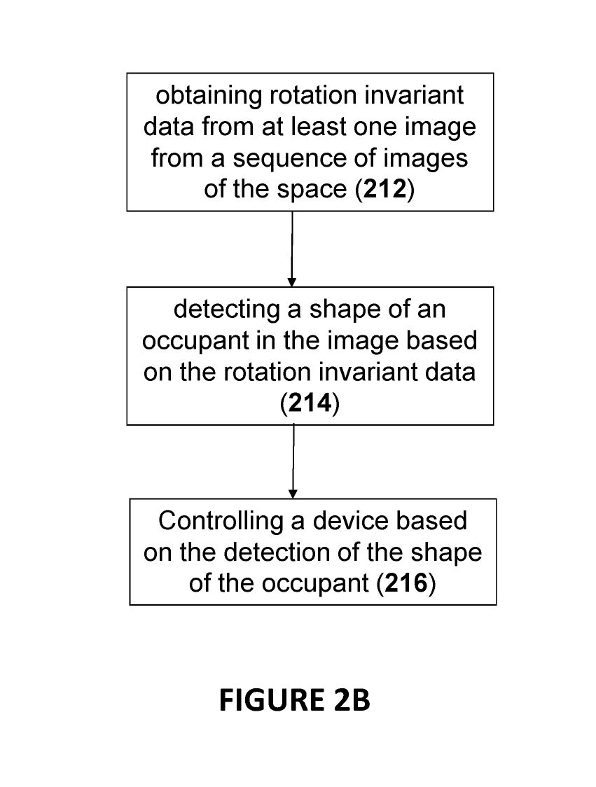

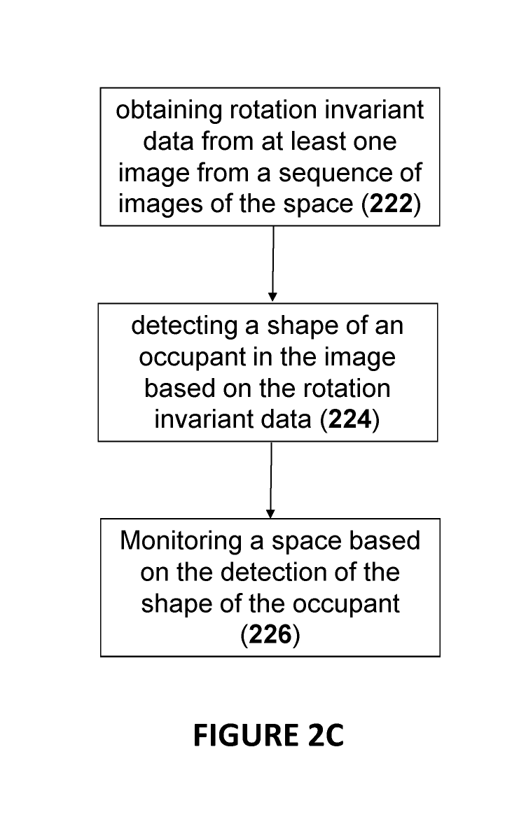

Methods for determining occupancy in a space, according to embodiments of the invention are schematically illustrated in FIGS. 2A-C.

According to one embodiment, which is schematically illustrated in FIG. 2A, a method for automatically determining occupancy in a space, includes the steps of obtaining rotation invariant data from at least one image from a sequence of images of the space (202); detecting a shape of an occupant in the image based on the rotation invariant data (204); and determining occupancy based on the detection of the shape of the occupant (206).

According to one embodiment, which is schematically illustrated in FIG. 2B, a method for automatically determining occupancy in a space, includes the steps of obtaining rotation invariant data from at least one image from a sequence of images of the space (212); detecting a shape of an occupant in the image based on the rotation invariant data (214); and controlling a device based on the detection of the shape of the occupant (216).

According to one embodiment, which is schematically illustrated in FIG. 2C, a method for automatically determining occupancy in a space, includes the steps of obtaining rotation invariant data from at least one image from a sequence of images of the space (222); detecting a shape of an occupant in the image based on the rotation invariant data (224); and monitoring a space based on the detection of the shape of the occupant (226).

Obtaining rotation invariant data may include, for example, obtaining rotation invariant descriptors from the image. At any image location, a rotation invariant descriptor can be obtained, for example; by sampling image features (such as color, edginess, oriented edginess, histograms of the aforementioned primitive features, etc.) along one circle or several concentric circles and discarding the phase of the resulting descriptor using for instance the Fourier transform or similar transforms. In another embodiment descriptors may be obtained from a plurality of rotated images, referred to as image stacks, e.g., from images Obtained by a rotating imager, or by applying software image rotations. Features stacks may be computed from the image stacks and serve as rotation invariant descriptors. In another embodiment, a histogram of features, higher order statistics of features, or other spatially-unaware descriptors provides rotation invariant data of the image. In another embodiment, an image or at least one features map may be filtered using at least one rotation invariant filter to obtain rotation invariant data.

In one exemplary embodiment the occupant is a human occupant and the shape of the occupant is a shape of a top view of a human. A shape of a top view of a human may include human specific features such as least one of a head, shoulder, leg, arm, face and hair. Human specific features may include other features, such as human skin color.

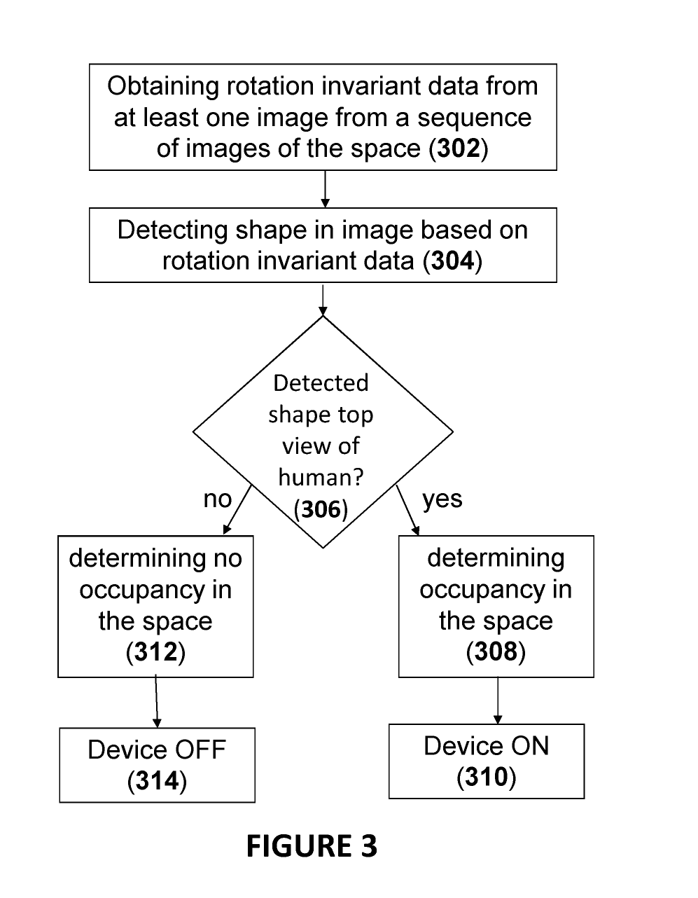

According to one embodiment which is schematically illustrated in FIG. 3, rotation invariant data is obtained from at least one image from a sequence of images of the space (302) and image processing algorithms (e.g., machine learning or pattern recognition algorithms) are applied using the rotation invariant data to detect a shape in the image (304). The image processing algorithms may include detecting human specific features such as a head, shoulder, leg, arm, face and hair. If the detected shape is a top view of a human (306) (a detection possibly aided by the detection of a human specific features as described above) then a determination of occupancy in the space is made (308) and a device may be controlled accordingly. For example, if there is a determination of occupancy (308) a device (e.g., lighting or HVAC device) may be turned on (310). If no shape of top view of a human is detected (306) then a “no occupancy” determination is made (312) and a device may be controlled accordingly. For example, if there is a determination of no occupancy (312) a device (e.g., lighting or HVAC device) may be turned off (314).

In some embodiments if there is a determination of occupancy appropriate information may be generated to a monitoring device. If no shape of top view of a human is detected then a “no occupancy” determination is made and appropriate information may be generated to a monitoring device.

Methods according to embodiments of the invention may include applying a shape detector to detect the shape of an occupant. For example, a detector configured to run a shape recognition algorithm (for example, an algorithm which calculates features in a Viola-Jones object detection framework), using machine learning techniques and other suitable shape detection methods may be used. Optionally, additional image parameters, such as color parameters, may be used to assist in detecting the shape of an occupant, e.g., the shape of a top view of an occupant.

Some methods according to embodiments of the invention include steps to assist in determining occupancy, specifically human occupancy. For example, some methods may include a step of identifying a human specific feature (such as described above) or detecting a predetermined human specific shape or element prior to detecting a shape of an occupant and/or applying shape detection algorithms only after or based on the identification of the human specific feature or element, thereby utilizing system resources more efficiently.

For example, an occupant may be required to look at an imager when entering a room (for example, to look at an imager on a ceiling of a room) such that the occupant's face or some other facial feature (such as eyes) may be detected by the imager (e.g., by applying known face and/or eye detection algorithms) and may be used to assist in determining occupancy according to embodiments of the invention. In another example, an occupant may be required to perform a specific, predefined hand posture or gesture (such as holding an open hand or a pointed finger or waving an open hand) when entering a room (or at another time during his occupancy) such that the posture or gesture may be detected by the imager and may be used to assist in determining occupancy according to embodiments of the invention. A posture or gesture of a hand may be detected by methods known in the art by applying motion and/or shape detection algorithms.

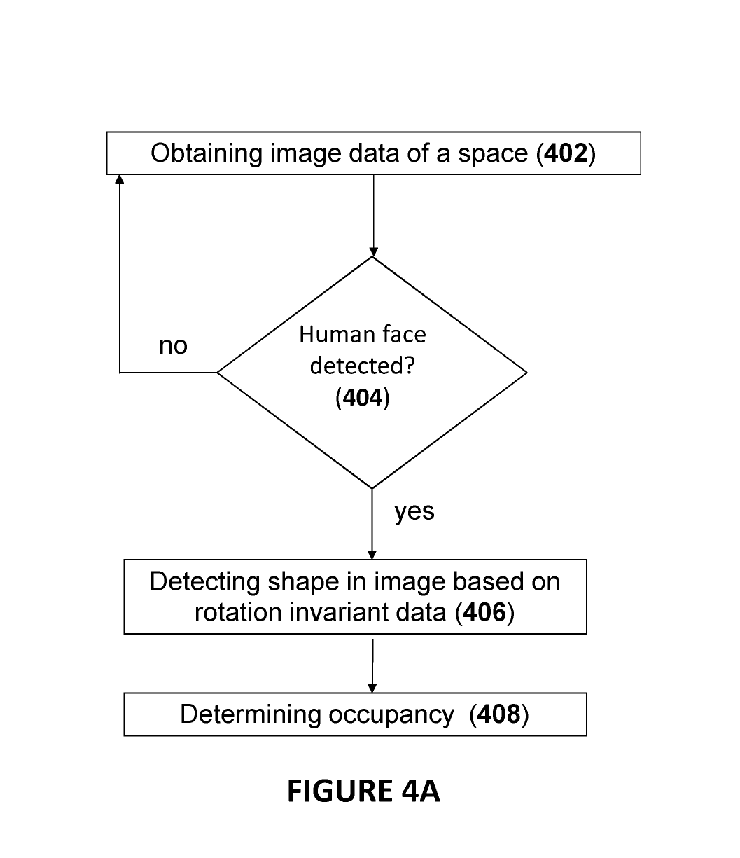

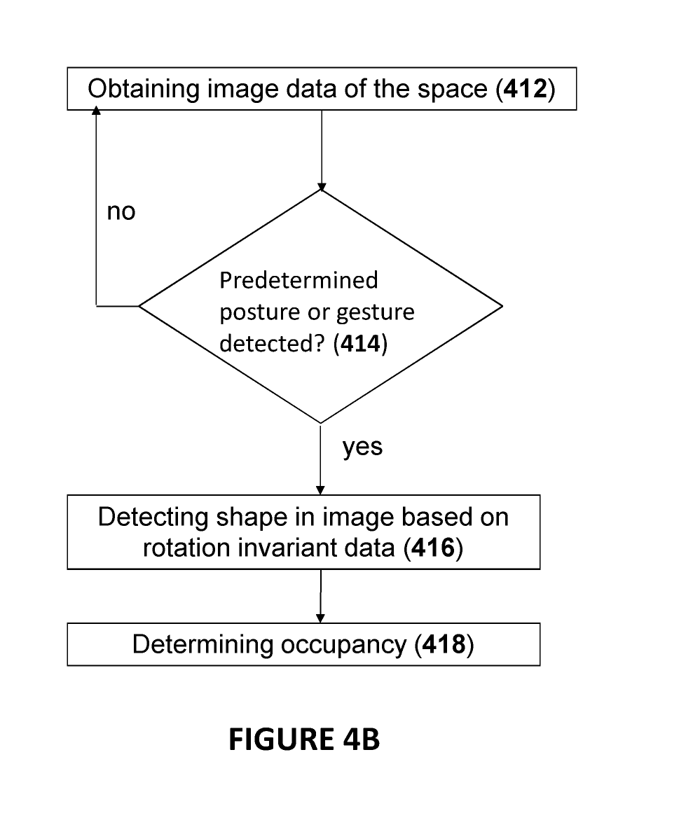

Some embodiments are schematically illustrated in FIGS. 4A and 4B.

The method illustrated in FIG. 4A may include detecting a human face or facial feature in at least one image of the space prior to detecting the shape of the occupant in the image of the space. For example, the method may include the steps of obtaining image data of a space (402), possibly a top view image of the space, and if a human face is detected in at least one image from the sequence of images (404) then shape detection algorithms may be applied to detect a shape of an occupant, based on rotation invariant data from a subsequent image from the sequence of images (406) and occupancy is determined based on the detection of the shape of the occupant (408).

In another embodiment, which is illustrated in FIG. 4B the method may include detecting a predetermined posture or gesture of a hand in at least one image of the space prior to detecting the shape of the occupant in the image of the space. For example, the method may include the steps of obtaining image data of a space (412), possibly a top view image of the space, and if a predetermined hand posture or gesture is detected in at least one image from the sequence of images (414) then shape detection algorithms may be applied to detect a shape of an occupant, based on rotation invariant data from a subsequent image from the sequence of images (416) and occupancy is determined based on the detection of the shape of the occupant (418).

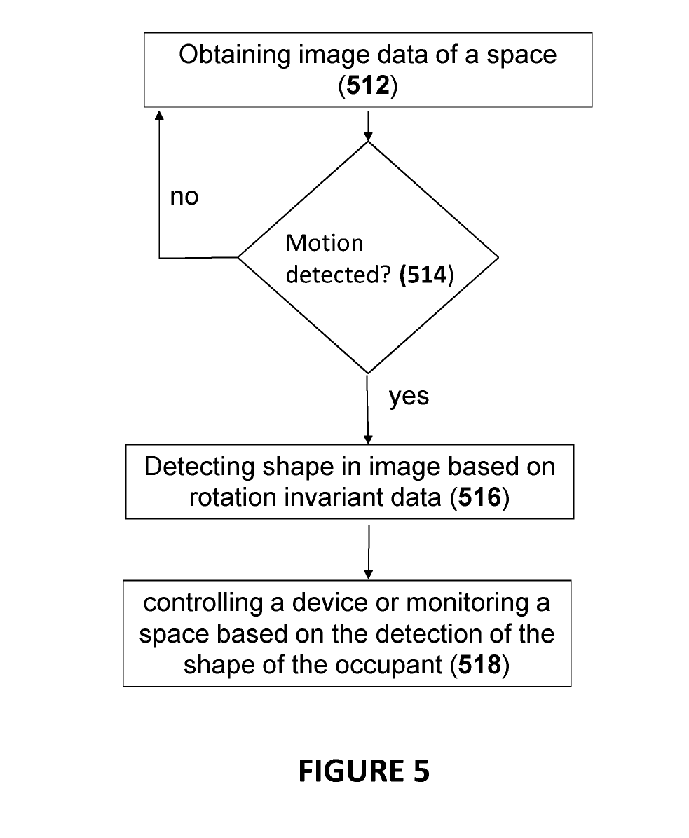

In another embodiment, which is schematically illustrated in FIG. 5, the method may include detecting motion in images of the space prior to detecting the shape of the occupant in the image of the space. For example, the method may include obtaining image data of a space (512), e.g., image data may include an image or sequence of images of the space. If motion is detected from images of the space (514) then shape detection algorithms may be applied (516) on an image or on a sequence of images to detect a shape of an occupant, based on rotation invariant data. For example, a shape detection algorithm (e.g., a machine learning process) may be run based on the detection of motion in images of the space. Based on the detection of the shape of the occupant a space may be monitored or a device may be controlled (e.g., as described above) (518).

In some embodiments the shape detection algorithms are applied at the location in the images where the motion was detected, thus the shape of the occupant is detected at a location of the detected motion in the image.

In some embodiments the motion is a predetermined motion type. Examples of motion types may include repetitive or non-repetitive motion, one dimensional or multi-dimensional motion, quick or slow motion, etc.

Typically, a predetermined motion type is a motion type associated with an occupant. For example, if a space is expected to be occupied by vehicles then the predetermined motion type would typically be a motion type typical of vehicles (e.g., one dimensional motion rather than multi-dimensional motion). If the space is expected to be occupied by humans then the predetermined motion type would typically be a motion type typical of humans (e.g., non-repetitive motion rather than repetitive motion).

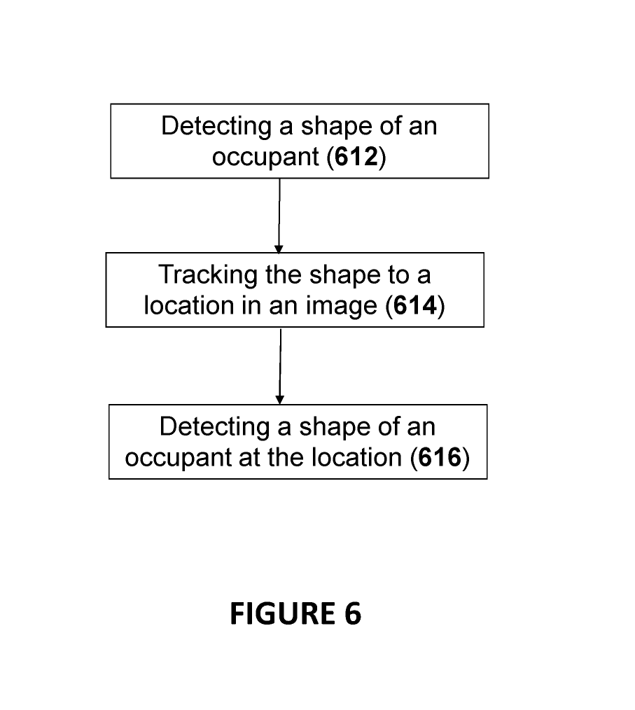

In one embodiment, which is schematically illustrated in FIG. 6, once a shape of an occupant is detected (612) the shape may be tracked to a location in an image (614) and shape detection algorithms may then be applied at that location in the image to detect the shape of the occupant at the location (616). Thus; shape detection algorithms may be applied once to detect the shape of an occupant, e.g., upon the occupant entering the space, whereas, additional (the same or other) shape detection algorithms may be applied periodically and locally (in a specific region of the image) based on tracking of the detected shape. Thus, occupancy over time or continued occupancy may be assisted by using tracking techniques requiring less use or more accurate use of shape detection algorithms, thereby determining occupancy more efficiently.

In one embodiment determining continued occupancy may be assisted by detecting, at the location in the image to which the occupant was tracked, a pixel difference between corresponding pixels in subsequent images in the sequence of images, a pixel difference which is above a predefined threshold (e.g., background noise); and determining occupancy in the space based on the detection of the shape and detection of the pixel difference.

Detecting a pixel difference may assist in detecting small movements, such as when a human occupant is sitting by a desk and typing.

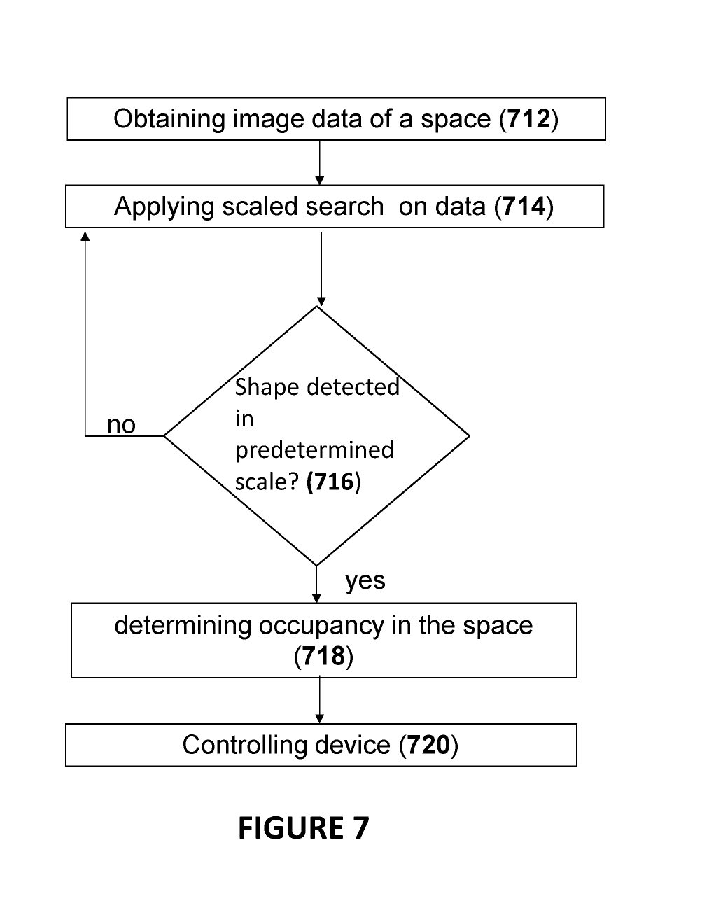

In one embodiment, which is schematically illustrated in FIG. 7, occupancy determination may be assisted by a scaled search of image data, typically adjusting the scale searched to an approximated; known size of an occupant. A method may include obtaining image data (e.g., one or more images) of a space (712) and applying a scaled search on the image data to detect the shape of the occupant in a predetermined scale (714). If the shape is detected in the predetermined scale (716) then occupancy is determined (718) and a device may be controlled (720), for example, as described above. Applying a scaled search enables to apply shape detection algorithms in a specific, limited area of the image thereby utilizing system resources more efficiently.

Embodiment of the invention accurately determine occupancy based on detection of a shape of an occupant based on rotation invariant image data and may also provide continued occupancy determination.

What is claimed is:

1. A method for automatically determining occupancy in a space, the method comprising:
detecting a shape of an occupant in an image of the space, using a rotation invariant image feature;
determining occupancy based on the detected shape; and
transmitting a signal based on the occupancy determination.

2. The method of claim 1 wherein using a rotation invariant image feature comprises:
obtaining rotation invariant data from the image of the space; and
detecting the shape of the occupant in the image based on the rotation invariant data.

3. The method of claim 1, comprising controlling a device based on the transmitted signal.

4. The method of claim 1 comprising monitoring the space based on the transmitted signal.

5. The method of claim 2 wherein obtaining rotation invariant data comprises one or more of the group consisting of obtaining rotation invariant descriptors from the image and obtaining descriptors from a plurality of rotated images of the space.

6. The method of claim 1 wherein the shape of the occupant is a shape of a top view of a human.

7. The method of claim 6 wherein the top view of a human comprises a top view of at least one of a head, shoulder, leg, arm, face, hair.

8. The method of claim 1 comprising detecting a human face or facial feature in at least one image of the space prior to detecting the shape of the occupant in the image of the space.

9. The method of claim 1 comprising detecting a predetermined posture or gesture of a hand in at least one image of the space prior to detecting the shape of the occupant in the image of the space.

10. The method of claim 1 comprising detecting motion in images of the space prior to detecting the shape of the occupant in the image of the space.

11. The method of claim 1 comprising:
applying a scaled search on the image to detect the shape of the occupant in a predetermined scale; and
determining occupancy if the shape of the occupant is detected in the predetermined scale.

12. The method of claim 1 comprising:
tracking the shape of the occupant to a location in an image of the space; and
applying a shape detection algorithm at the location to detect the shape of the occupant at the location.

13. A method for automatically determining occupancy in a space, the method comprising:
obtaining image data of the space;
detecting motion in the space from the image data;
based on the detection of motion applying a shape detection algorithm to detect a shape of the occupant using rotation invariant data; and
determining occupancy in the space based on the detected shape.

14. The method of claim 13 comprising:
detecting motion at a location in an image of the space; and
applying the shape detection algorithm at the location in the image of the detected motion.

15. The method of claim 13 wherein motion is a predetermined motion type.

16. A system for automatically determining occupancy in a space, the system comprising:
an imager configured to obtain a top view image of the space; and
a processor in communication with said imager, the processor to
detect a shape of an occupant in the top view image based on rotation invariant data, and
provide a determination of occupancy based on the detection of the shape of the occupant.

17. The system of claim 16 wherein the processor is to monitor the space.

18. The system of claim 16 wherein the processor is in communication with a device and wherein the processor is to control the device based on the determination of occupancy.

19. The system of claim 17 wherein the device comprises an environment comfort device.

20. The system of claim 17 wherein the device comprises a central control unit of lighting or of HVAC devices.
